(19) United States
(12) Patent Application Publication
(10) Pub. No.: US 2012/0155983 A1
(43) Pub. Date: Jun. 21, 2012

(54) Restraint Device and Method

(76) Inventor: Kerri La Londe, Regina (CA)

(21) Appl. No.: 13/242,330

(22) Filed: Sep. 23, 2011

Related U.S. Application Data
(60) Provisional application No. 61/385,615, filed on Sep. 23, 2010.

(51) Int. Cl. B60P 7/06; A44B 11/00; F16B 2/00; A44B 99/00

(52) U.S. Cl. 410/98; 24/305; 24/307; 24/326

(57) ABSTRACT

A restraint device features a section of strap, a connection member at a first end of the strap; and a freely flexible stop member of greater thickness at the second end of strap. The strap is placed in a gap between two objects which are then secured in stationary positions relative to one another. The thickness of the stop member prevents withdrawal of the strap through the gap from one side. The connection member on the other side is coupled to a body to be restrained, which is also exceeds the gap size. In use as an adult novelty restraint, the stop member flexibility limits noise if banged against a door or bed frame retaining the strap. As a vehicle rooftop load restraint using a door or window of the vehicle to retain the strap, the flexibility of the stop member limits noise and prevents damage to the window glass.

### CROSS REFERENCE TO RELATED APPLICATIONS

This application claims benefit under 35 U.S.C. 119(e) of U.S. Provisional Patent Application Ser. No. 61/385,615, filed Sep. 23, 2010.

### FIELD OF THE INVENTION

The present invention relates generally to restraints, and more particularly relates to restraint devices of the type usable as an adult novelty to restrain a participant using a doorway as an anchor point to avoid the need for bulky, oversized equipment.

### BACKGROUND OF THE INVENTION

In the adult novelty product industry, over the door restraints are known for use in restraining one's companion without requiring a Saint Andrew's Cross (X-shaped frame) or other bulky structure to provide anchor points for securing the participant's hands by way of adorned wrist cuffs. These known over the door restraints each feature a ring or clasp at one end of a short fixed-length strap and a cylindrical rod or dowel traversing the strap at the opposite end. While the strap's relatively low thickness is thin enough to fit in the small gap between a typical household door and surrounding frame, the diameter of the rod is large enough to not fit into this gap. Accordingly, with the door open, a user hangs the strap over the door to place the ring or clasp on one side of the door, and the rod on the other. The door is then closed, automatically securing the door in this closed position in this position by the door's conventional latch, and preferably locked if possible. The clasp or ring is then coupled with the corresponding ring on a wrist cuff worn by the participant. The participant is thus restrained on the respective side of the door, unable to move too far away from the door since the rod on the opposite side of the door cannot be pulled through the small gap between the door and its frame. Two restraints may be used, one per wrist, if desired, or both wrists may be secured to a single restraint positioned centrally over the participant's head.

Applicant has developed a new version of these restraints offering advantageous improvements over the above-described commercially available units. Although initially intended for use in the same manner as an adult novelty, it will become apparent from the following disclosure that the restraints may be useful in other applications as well, for example in securing rooftop cargo on an automobile.

### SUMMARY OF THE INVENTION

According to a first aspect of the invention there is provided a restraint device comprising:

a section of strap having a first end and a second opposing end;

a connection member carried on the section of strap adjacent the first end thereof; and

a freely flexible stop member carried on the section of strap adjacent the second end thereof and being greater in thickness than the strap.

Preferably the freely flexible stop member comprises a flexible container containing a flexible volume of filler material therein.

Preferably the filler material comprises granular material.

Preferably the filler material comprises sand.

Preferably the flexible container comprises a fabric pouch.

Preferably the section of strap is adjustable in length between the first and second ends.

Preferably there is provided a slide buckle operably coupled with the section of strap to facilitate selective length adjustment thereof.

Preferably the section of strap comprises webbing.

Preferably the connection member comprises an openable and closeable fastener.

Preferably the connection member comprises a clasp.

According to a second aspect of the invention there is provided a restraint method comprising:

providing a first restraint device according to the first aspect of the invention;

positioning a portion of the section of strap of the first restraint device in a gap between two objects so that the section of strap of the first restraint device extends through the gap to position the connection member and the stop member of the first restraint device outside the gap on respective opposing sides thereof, the thickness of the freely flexible stop member of the first restraint device exceeding a thickness of the gap;

securing the two objects in stationary positions relative to one another; and

coupling the connection member with a first connection element associated with a body to be restrained, the body being too large to pass through the gap between the two objects;

whereby an inability to fit the stop member and the body through the gap from the respective sides thereof prevents full withdrawal of the strap section from between the two objects, the strap thereby retaining the body proximate the two objects.

The device may be used as an adult novelty device to restrain the body of a person by connecting to a metal ring or other connection element worn by that person, in which case the two objects may comprise a door frame and a door operably mounted for opening and closing a doorway bound by said door frame, or may comprise a bed frame and a mattress or box spring seated upon said bed frame.

In another embodiment, the device may be used in securing a load to the roof of a vehicle, in which case the method preferably includes:

providing a second restraint device;

positioning a portion of the section of the strap of the second restraint device in a second gap between two additional objects so that the section of strap of the second restraint device extends through the second gap to position the connection member and the stop member of the second restraint device outside the second gap on respective opposing sides thereof, the thickness of the freely flexible stop member of the second restraint device exceeding a thickness of the second gap;

securing the two additional objects in stationary positions relative to one another; and

coupling the connection member of the second restraint device with a second connection element associated with the body to be restrained, the body being that of an object to be secured atop an automobile for transport;

wherein the restraint devices are installed at different door locations of the automobile and the connection elements are carried on a common tie-down element extending over the automobile between the different door locations to secure the body against a roof of the automobile.

The two objects may be a window frame of the automobile and a window supported in a respective door of the automobile for selective movement between open and closed positions, the step of securing the two objects in stationary positions relative to one another comprising moving the window toward the closed position to clamp the section of strap between the window and the window frame.

The window frame may be part of the respective door of the automobile.

Alternatively, the two objects may be a door frame of the automobile and a door operably mounted for opening and closing a doorway bound by said door frame, the step of securing the two objects in stationary positions relative to one another comprising closing the door to clamp the section of strap between the door and the door frame of the automobile.

### BRIEF DESCRIPTION OF THE DRAWINGS

In the accompanying drawings, which illustrate exemplary embodiments of the present invention:

FIG. 1 is a schematic plan view of a restraint device of the present invention, having been laid out flat for clear illustration of its components.

FIG. 2 is a schematic cross-sectional view of a doorway in which the restraint device has been hung for use.

FIG. 3 is a schematic end view of a bed frame on which the restraint device has been hung for use.

FIG. 4 is a schematic perspective view of an automobile on which multiple restraint devices are in use to secure a rooftop load on the vehicle.

### DETAILED DESCRIPTION

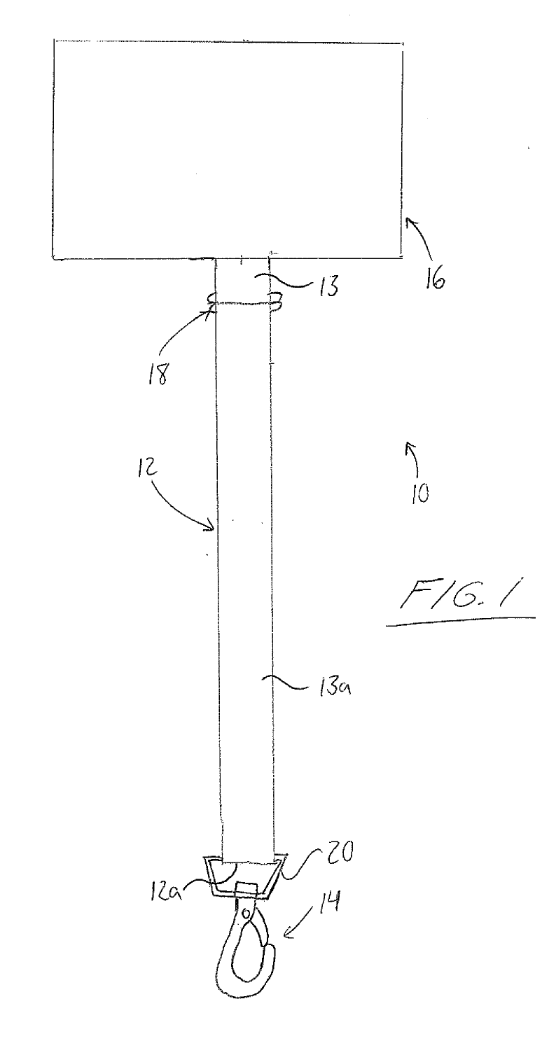

FIGS. 1 to 3 show a restraint device 10 according to one embodiment of the present invention. The device features a central strap section 12 made up of a length of flat narrow webbing 13. A clasp 14 is secured to the strap section 12 at one end thereof, and a fabric pouch 16 filled with sand or other granular material is fixed to the strap section 12 at a second end opposite the clasp 14. The clasp equipped end 12a of the strap section 12 is defined by a folded over portion 13a of the length of webbing, the end of which is anchored to a sliding buckle 18 slidably disposed on the single layer portion of the webbing extending from the pouch 16 to the clasp 14. The clasp 14 is carried on a ring 20 through which the doubled or folded over portion of the webbing passes to secure the clasp 14 on the strap section 12. Displacement of the sliding buckle 18 along the webbing 13 changes the length of the folded over portion 13a thereof, thereby changing the effective length of the overall strap portion 12 between the pouch 16 and the fold 12a in the webbing 13 where the clasp ring 20 hangs the clasp 14 therefrom.

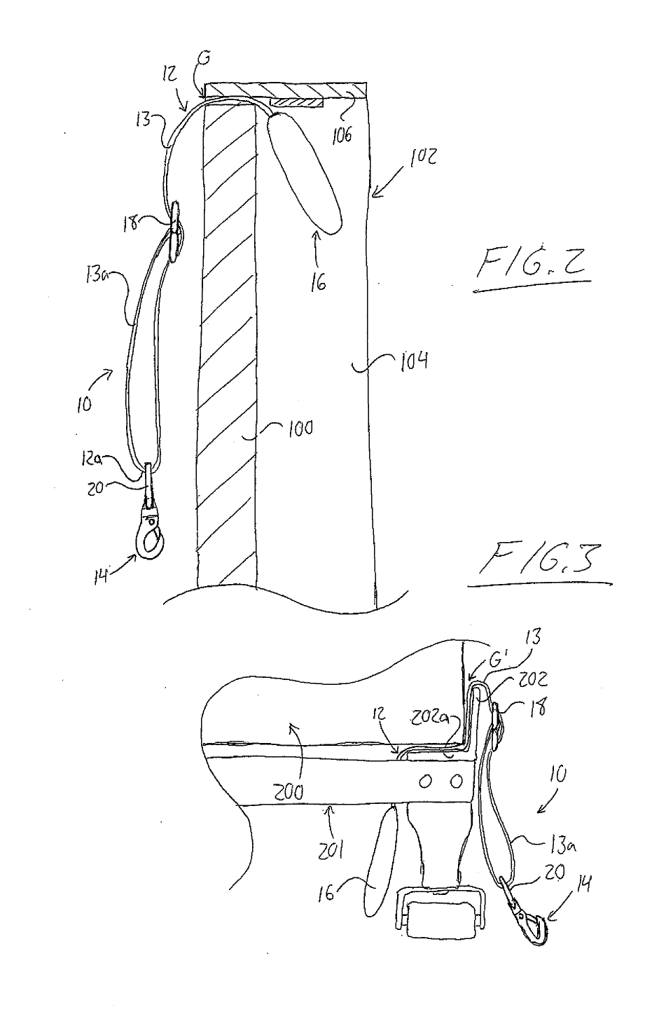

FIG. 2 shows the restraint device 10 installed in a doorway in the same manner as the prior art devices described above for use as an adult novelty for restraining a partner at a position near the door. In a conventional manner, a door 100 is pivotally hung on a door frame 102 by hinges (not shown) connecting one side edge of the door panel 100 to a respective door jamb 104 of the door frame 102 so that the door can swing into and out of a closed position substantially closing of the doorway opening framed by the door frame. A door latch (not shown) operates in a conventional manner to automatically secure the door in the closed position by releasably engaging with an opening in a striker plate on the other jamb (not shown) of the door way; until the latch is subsequently released through manual operation of a knob or handle controlling the latch mechanism. The door 100 is shown secured in the closed position with the restraint device 10 having been suitably placed prior to closing of the door in the same manner as the prior art. Accordingly, the strap section 12 passes through a vertical gap G between the top edge of the door 100 and the header 106 of the door frame 102 horizontally interconnecting the door jambs above the door 100, and the pouch 16 and the clasp 14 are accordingly disposed at the ends of the strap section 12 on opposite sides of the door 100.

A willing participant can thus be restraint proximate the doorway by coupling of the openable and closable clasp fastener 14 to the ring of a wrist cuff worn by the participant. As long as the door 100 remains closed, the restraint device is effectively anchored in the doorway, as the pouch 16 has a thickness that exceeds the height of the vertical gap G between the door 100 and the header 106, and thus cannot be pulled through the gap G from the outer side of the door to the inner side thereof, at which the clasp 14 and restrained participant are located. Just as the pouch 16 thus prevents full withdrawal of the strap section 12 from between the door and the frame to the inside of the door, the person's body coupled to the clasp 14 of course cannot fit between the door and the frame, thus preventing withdrawal of the restraint device from the gap in the other direction toward the outer side of the door. Even if nobody is coupled to the restraint device at a particular moment, and the pouch outweighs the parts of the device hanging on the inside of the door so as to pull more of the strap through the gap to where the pouch is falling on the outside of the door, full withdrawal of the device from the installed position between the door and its frame is prevented by failure of at least one of the slide buckle 18 and clasp 14 to fit through the gap G. Accordingly, the restraint connection point provided by the clasp member 14 always remains on the inside of the door for ready availability to a user so long as the door remains closed. To remove the restraint device when no longer needed, the door is simply opened and the device is removed or allowed to fall from atop the door.

In the above description, the inner side (or inside) and outer side of the door are used only to distinguish between the two sides thereof, with inner side referring to the side of the door on which a user is to be restrained. In other words, inside is used to denote the side of the door to which the participants are located during use of the restraint, and is not intended to limit the position of the clasp to an indoor environment or enclosed room during use of the inventive restraint.

The restraint device presents advantages over those of the prior art in the use of a length-adjustable strap and use of a pouch of granular material as a freely flexible stop member for blocking sliding of the strap section from out of the gap between the door and the frame.

The length adjustable strap allows a user to set the height to which the clasp 14 hangs from the top of the door so that the restraint device can be adjusted to accommodate different users, different restraint positions or different connection points where the restraint device is to be coupled to the user. For example, adjusted to sufficient length to hang far enough below the top of the door, the restraint can be used to connect to wrist cuffs without requiring that the participant's arms be held in a raised overhead position, or can even be connected to restraint points other than wrist-worn cuffs. The restraint device is therefore more flexible and adaptable than prior art over the door restraints.

The pouch of granular material, featuring a flexible fabric pouch and sand or other granular material of relatively small grain size allowing the grains to flow or move past each other to change the shape of the volume of granular material and thereby retain an overall flexibility of the grain filled pouch, presents an advantage over the hard plastic, metal or wood rods used as stop members in the prior art. The flexible bag or pouch of sand is notably softer or less rigid, and thus produces less noise if banged against the door when the restraint strap is pulled away from the door by the restrained party. Accordingly, the restraint device of the present invention produces less disruption and attracts less attention than the prior art restraints when in use at a location where people other than the participants may be present. This sound preventing, impact absorbing functionality is maximized by using a stop member that is freely flexible under its own weight. That is, if half of the pouch is supported, for example gripped in a person's hand, the weight of the other unsupported half causes the pouch to bend or flex under its own weight. Accordingly, great external force is not required to flex the pouch and its contents, and this free flexibility helps absorb impact to soften contact between the stop and another object (e.g. the door or frame of FIG. 2) to minimize the noise of such contact compared to the relatively rigid stop members of the prior art.

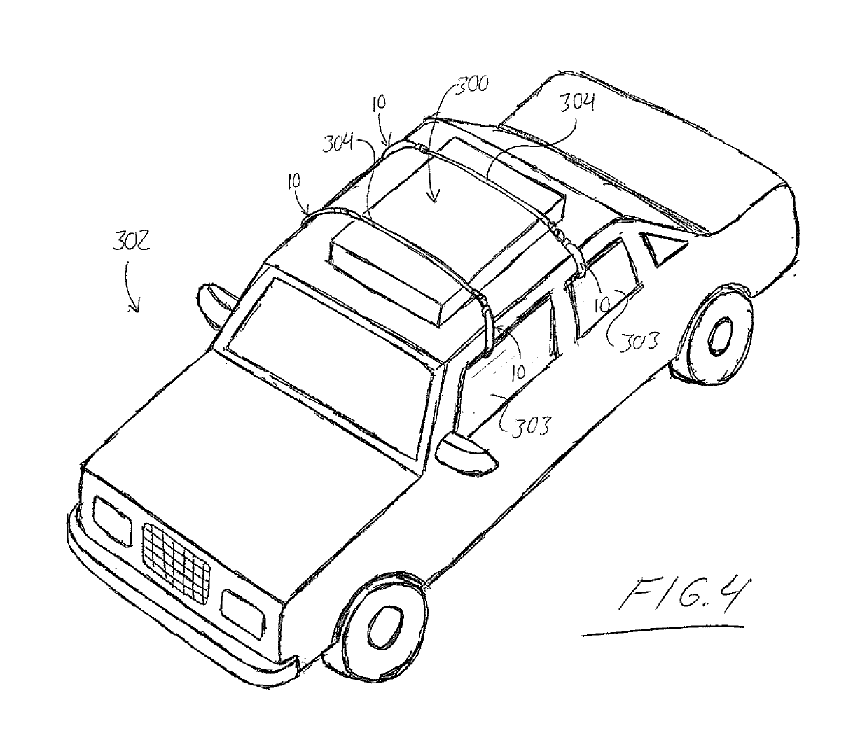

FIG. 3 shows the same restraint device in use on a bed to demonstrate how the device may be used at locations other than a doorway while operating in a similar manner to employ existing conventional household furniture or objects to provide an anchoring point to secure the restraint in place for use on a participant. In this figure, the strap section 12 passes through a gap G′ between a mattress or box spring 200 and a bed frame 201 on which the mattress or box spring is seated. The illustrated bed frame employs a conventional rail 202 of L-shaped cross section to seat the mattress or box spring 200 atop the horizontal bottom leg 202a of the rail's L-shaped section and between the vertical legs of two such parallel rails on opposite sides of the mattress or box spring 200. To install the restraint device 10, the mattress or box spring 200 is lifted slightly off the bottom leg 202a of the rail 202 and the strap section 12 is fed partly over the rail beneath the lifted mattress or box spring 200 so that the single layer of webbing between the pouch 16 and the buckle 18 overlies the rail 202. The mattress or box spring 200 is then dropped or lowered back onto the horizontal leg 202a of the rail, thereby re-seating the mattress or box spring 200 on the frame 201, but now with the strap section 12 of the restraint device clamped in place between the mattress or box spring 200 and the frame rail 202 by the weight of the mattress or box spring 200 and anything located atop the mattress or box spring.

The pouch 16 hangs from the bed frame rail 202 on the inner side thereof beneath the mattress or box spring 200, with the buckle 18 and clasp 14 thus positioned outside the bed frame on the opposite side of the rail 202 so as to be accessible to a user. The pouch 16 again acts as a soft and flexible, and thus quiet, stop member preventing full withdrawal of the strap 12 from between the objects used to retain the restraint device by exceeding the size of the gap G′ between the objects 200, 202. Like the latching of the door in FIG. 2, the seating of the mattress or box spring 200 on the bed frame 201 acts to automatically secure the restraint device in place between the two objects until manual steps to later separate the objects and remove the restraint device from between them are taken. When the device is no longer needed, the mattress or box spring 200 is simply lifted slightly from off the horizontal leg of the bed frame rail to enlarge the gap G′ therebetween to a size sufficient to accommodate passage of the pouch 16 or buckle and clasp therethrough, at which point the strap can be pulled fully through the gap to uninstall the device.

The restraint device of the present invention is also useful in contexts other than personal restraint, as demonstrated by FIG. 4, in which four of the devices 10 from FIGS. 1 to 3 are employed to secure a rooftop load 300 on an automobile 302.

In the figure, each restraint device 10 is clamped in place between the movable window of a respective door of the four-door automobile and the window frame of that door by raising the window 303 toward its closed position to secure the strap of the restraint device between the top edge of the window and the portion of the window frame extending across the top of the door's window space. The soft flexible pouch thus hangs inside the interior passenger cabin of the vehicle, acting as a stop preventing the device from being pulled fully outside the vehicle, while limiting noise and preventing damage to the door's window glass due to the pouch's flexibility. A tie down strap 304 with a hook or ring secured thereto at each end has one of these hooks or rings coupled to the clasp 14 of a respective restraint device 10, and the other hook or ring likewise coupled to the clasp 14 of another restraint device 10 positioned at a door on the opposing side of the vehicle 302. In this connection between two restraint devices, the tie down strap 304 passes over the object 300 to be stowed atop the roof of the vehicle 302.

Each tie down strap or cord is elastic or resilient and is of a short enough length to require stretching from its normal default length to connect between the respective two restraint devices. Accordingly, the tie down pulls the pouch of each restraint device against the inner face of the respective window, thereby tending to pull the strap 12 to the exterior of the vehicle. Complete withdrawal of the restraint from the gap between the top edge of the window and the part of the window frame passing over the window is prevented by the window having been closed to a degree making this gap smaller than the thickness of the pouch 16. Each restraint device is preferably manually pulled to a maximum extent outside the vehicle prior to closing the window to its maximum achievable level of closing. This way, later connection of the tie-down between two restraints cannot pull the restraint devices any further outward from the vehicle cabin, and so the tightness of the tie-down against the cargo load is known to be the maximum achievable by the combination of that tie-down with those two restraint devices.

The restraints may similarly be employed in an automotive rooftop cargo context by using the vehicle door and door frame to clamp the straps in place instead of the window and window frame. In such use, the restraints would be held in place in a similar manner as described with regard to FIG. 2, that is, by clamping the strap of each restraint device between the door and the corresponding door frame. Where the automobile has a frameless-window door, the result would be much the same as described above with regard to FIG. 4, in that the top edge of the door would be defined by the top edge of the window, and so the restraint strap would be clamped in place between the window and the part of the vehicle that frames the window when the vehicle door is closed. With a frameless-window automotive door, it may be possible to secure the restraint device in place either by closing the door when the window is already in its fully raised position, or by installing the device with the door already closed by raising the window toward its closed position.

Elastic or resilient tie-downs need not necessarily be used, since, for example, rope, string or cable could instead be tied to the connection clasps of the restraint devices, or to other suitable anchor points on the vehicle, in a manner acting to extend the rope, string or cable between the two restraint devices in a tight conditions.

It will be appreciated that the restraint devices need not necessarily be adjustable in length, and that fixed length straps may be safer in the automotive tie-down context by better ensuring that inadvertent lengthening of the straps doesn't loosen the position of the tie-down over the rooftop object to be transported by the automobile. Likewise, although the adjustable length strap is advantageous in adult novelty applications of the restraint device, it may be produced with a fixed-length strap while still benefiting from the soft flexible sand pouch stop member compared to prior art restraints. In place of the openable and closeable claps, permanently closed rings or other connection members may be used on the straps, with users then relying on tying or other fastening techniques to couple the connection member to the person or other body to be restrained.

As an example of possible materials and dimensions, the restraint 10 may be produced with a sewn fabric pouch 4.5 inches long and 3 inches wide and containing approximately 0.25 pounds of sand, a strap of polypropylene webbing 0.75 inches wide and adjustable anywhere between 8.5 and 16 inches long, a metal slide buckle and a swiveling metal clasp. It will be appreciated however that these materials and dimensions are presented as examples only, and are not intended to limit the scope of the present invention.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A restraint device comprising:
a section of strap having a first end and a second opposing end;
a connection member carried on the section of strap adjacent the first end thereof; and
a freely flexible stop member carried on the section of strap adjacent the second end thereof and being greater in thickness than the strap.

2. The restraint device of claim 1 wherein the freely flexible stop member comprises a flexible container containing a flexible volume of filler material therein.

3. The restraint device of claim 2 wherein the filler material comprises granular material.

4. The restraint device of claim 2 wherein the filler material comprises sand.

5. The restraint device of claim 2 wherein the flexible container comprises a fabric pouch.

6. The restraint device of claim 1 wherein the section of strap is adjustable in length between the first and second ends.

7. The restraint device of claim 6 comprising a slide buckle operably coupled with the section of strap to facilitate selective length adjustment thereof.

8. The restraint device of claim 1 wherein the section of strap comprises webbing.

9. The restraint device of claim 1 wherein the connection member comprises an openable and closeable fastener.

10. The restraint device of claim 1 wherein the connection member comprises a clasp.

11. A restraint method comprising:
providing a first restraint device comprising a section of strap having a first end and a second opposing end, a connection member carried on the section of strap adjacent the first end thereof; and a freely flexible stop member that is carried on the section of strap adjacent the second end thereof and is greater in thickness than the strap;
positioning a portion of the section of the strap of the first restraint device in a gap between two objects so that the section of strap of the first restraint device extends through the gap to position the connection member and the stop member of the first restraint device outside the gap on respective opposing sides thereof, the thickness of the freely flexible stop member of the first restraint device exceeding a thickness of the gap;
securing the two objects in stationary positions relative to one another; and
coupling the connection member with a first connection element associated with a body to be restrained, the body being too large to pass through the gap between the two objects;
whereby an inability to fit the stop member and the body through the gap from the respective sides thereof prevents full withdrawal of the strap section from between the two objects, the strap thereby retaining the body proximate the two objects.

12. The restraint method of claim 11 wherein the two objects comprise a door frame and a door operably mounted for opening and closing a doorway bound by said door frame.

13. The restraint method of claim 11 wherein the two objects comprise a door frame of a dwelling and a door operably mounted for opening and closing a doorway bound by said door frame.

14. The restraint method of claim 11 wherein the two objects comprise a bed frame and a mattress seated upon said bed frame.

15. The restraint method of claim 11 wherein the two objects comprise a bed frame and a box spring seated upon said bed frame.

16. The restraint method of claim 11 wherein the body to be restrained is the body of a person wearing the connection element.

17. The restraint method of claim 11 comprising:
providing a second restraint device according to any one of claims 1 to 10;
positioning a portion of the section of the strap of the second restraint device in a second gap between two additional objects so that the section of strap of the second restraint device extends through the second gap to position the connection member and the stop member of the second restraint device outside the second gap on respective opposing sides thereof, the thickness of the freely flexible stop member of the second restraint device exceeding a thickness of the second gap;
securing the two additional objects in stationary positions relative to one another; and
coupling the connection member of the second restraint device with a second connection element associated with the body to be restrained, the body being that of an object to be secured atop an automobile for transport;
wherein the restraint devices are installed at different door locations of the automobile and the connection elements are carried on a common tie-down element extending over the automobile between the different door locations to secure the body against a roof of the automobile.

18. The method of claim 17 wherein the two objects comprise a window frame of the automobile and a window supported in a respective door of the automobile for selective movement between open and closed positions, the step of securing the two objects in stationary positions relative to one another comprising moving the window toward the closed position to clamp the section of strap between the window and the window frame.

19. The method of claim 18 wherein the window frame is part of the respective door of the automobile.

20. The method of claim 17 wherein the two objects are a door frame of the automobile and a door operably mounted for opening and closing a doorway bound by said door frame, the step of securing the two objects in stationary positions relative to one another comprising closing the door to clamp the section of strap between the door and the door frame of the automobile.
